(19) United States
(12) Patent Application Publication
(10) Pub. No.: US 2018/0321406 A1
(43) Pub. Date: Nov. 8, 2018

(54) NARROW TOW MARINE VIBRATORS FOR SIMULTANEOUS SWEEPS

(71) Applicant: PGS Geophysical AS, Oslo (NO)

(72) Inventors: Christian Strand, Houston, TX (US); Manuel Beitz, Houston, TX (US); Okwudili Orji, Drammen (NO); Averrouz Mostavan, Houston, TX (US); Stig Rune Lennart Tenghamn, Houston, TX (US); Anders Göran Mattsson, Singapore (SG)

(21) Appl. No.: 15/967,969

(22) Filed: May 1, 2018

Related U.S. Application Data
(60) Provisional application No. 62/502,142, filed on May 5, 2017.

(51) Int. Cl. G01V 1/38

(52) U.S. Cl. CPC G01V 1/3808; G01V 2210/127; G01V 1/3843

(57) ABSTRACT

Techniques are disclosed relating to geophysical surveying. In some embodiments, a marine survey vessel tows multiple sensor streamers including a group of four innermost streamers in a cross-line direction relative to a centerline of tow. In some embodiments, the vessel tows two or more vibratory sources between two outermost streamers in the first group, in a cross-line direction. In some embodiments, the two or more sources are simultaneously operated using different codes that are uncorrelated to at least a threshold degree. Various disclosed narrow-tow techniques may allow increased streamer separation without reducing cross-line bin size and/or reduce cross-line bin size for a given streamer separation, relative to conventional techniques.

This application claims the benefit of U.S. Provisional Application No. 62/502,142, filed on May 5, 2017, which is incorporated by reference herein in its entirety.

### BACKGROUND

Geophysical surveys are often used for oil and gas exploration in geophysical formations, which may be located below marine environments. Seismic geophysical surveys, for example, are based on the use of acoustic waves. In marine seismic surveys, a survey vessel may tow an acoustic source (e.g., an air gun or a marine vibrator) and a plurality of streamers along which a number of acoustic sensors (e.g., hydrophones and/or geophones) are located. Acoustic waves generated by the source may then be transmitted to the earth's crust and then reflected back and captured at the geophysical sensors. Data collected during a marine geophysical survey may be analyzed to locate hydrocarbon-bearing geological structures, and thus determine where deposits of oil and natural gas may be located.

A typical goal in geophysical marine surveys is to balance adequate regularity in spacing of signal sources and geophysical sensors with reasonable acquisition cost. Achieving desired coverage with less equipment (e.g., streamers with wider spacing) may reduce system complexity and cost and may help avoid physical entanglement of streamers. Using less equipment, however, may generally result in coarser spatial sampling with a corresponding decrease in data resolution, e.g., when imaging geological formations.

### BRIEF DESCRIPTION OF THE DRAWINGS

FIG. 1 is a block diagram illustrating an exemplary geophysical survey system with narrow-towed vibratory sources, according to some embodiments.

FIG. 2 is a block diagram illustrating exemplary strings of narrow-towed vibratory sources, according to some embodiments.

FIG. 3 is a diagram illustrating exemplary relationships between sets of innermost streamers and the narrow towing area for sources, according to some embodiments.

FIGS. 4A and 4B are diagrams illustrating exemplary bin size for different numbers of sources and different streamer separations.

FIG. 5 is a flow diagram illustrating an exemplary method for conducting a survey using narrow-towed vibratory sources, according to some embodiments.

FIG. 6 is a block diagram illustrating one embodiment of a computing system.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Various units, circuits, or other components may be described or claimed as “configured to” perform a task or tasks. In such contexts, “configured to” is used to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112(f) for that unit/circuit/component.

It is to be understood the present disclosure is not limited to particular devices or methods, which may, of course, vary. It is also to be understood that the terminology used herein is for the purpose of describing particular embodiments only, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected.

### DETAILED DESCRIPTION

Exemplary Survey System with Narrow-Towed Sources

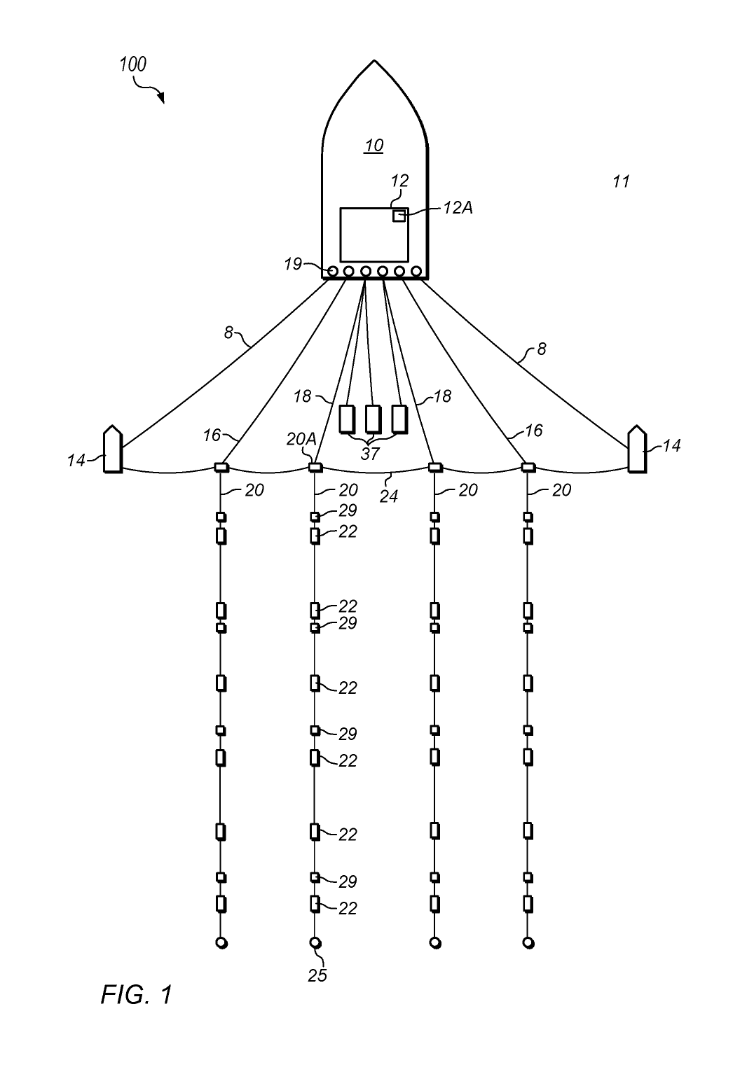

Referring to FIG. 1, a block diagram illustrating an exemplary embodiment of a geophysical survey system 100 is shown. In the illustrated embodiment, system 100 includes survey vessel 10, signal sources 37, paravanes 14, and streamers 20. In the illustrated embodiment, sources 37 are towed narrowly behind vessel 10.

In some embodiments, sources 37 are vibratory sources configured to operate simultaneously using orthogonal codes, such that sensor measurements based on energy emitted from the different sources 37 can be differentiated. For example, U.S. Pat. No. 8,094,514 titled “Seismic Vibrator Array and Method for Using” discusses exemplary designs of vibratory sources and techniques for distinguishing between signals from different vibratory sources when operating simultaneously. Gold sequences and m-sequences are examples of codes that may be used to drive vibratory sources and may have little or no cross-correlation between different codes. Cross-correlation of received signals with known codes used to drive the sources may allow separation of signals from different sources. Speaking generally, codes may be used to drive different vibratory sources where the codes are uncorrelated to at least a threshold degree to facilitate separation of signals from different vibratory sources. During simultaneous operation, different vibratory sources may perform sweeps using different codes at the same time. Subsequently to the simultaneous sweeps, the vibratory sources may cease operation to allow a listening period in which sensors on streamer 20 record reflected energy from the sweeps.

Using vibratory sources simultaneously may allow an increase in the number of sources used without reducing fold (in contrast, adding additional air gun sources, for example, may reduce fold because of the need to activate sources at different times and adding more air guns may increase the time between activation of each source). Note that fold refers to the number of source/receiver pair reflections recorded in each common mid-point (e.g., within each bin). In the illustrated embodiment, three differentiable sources 37 are towed narrowly behind vessel 10 (between the two innermost streamers 20 in a cross-line direction, in the illustrated example). Note that the term “cross-line” refers to a direction perpendicular to the direction of travel while the term “in-line” refers to a direction parallel to the direction of travel.

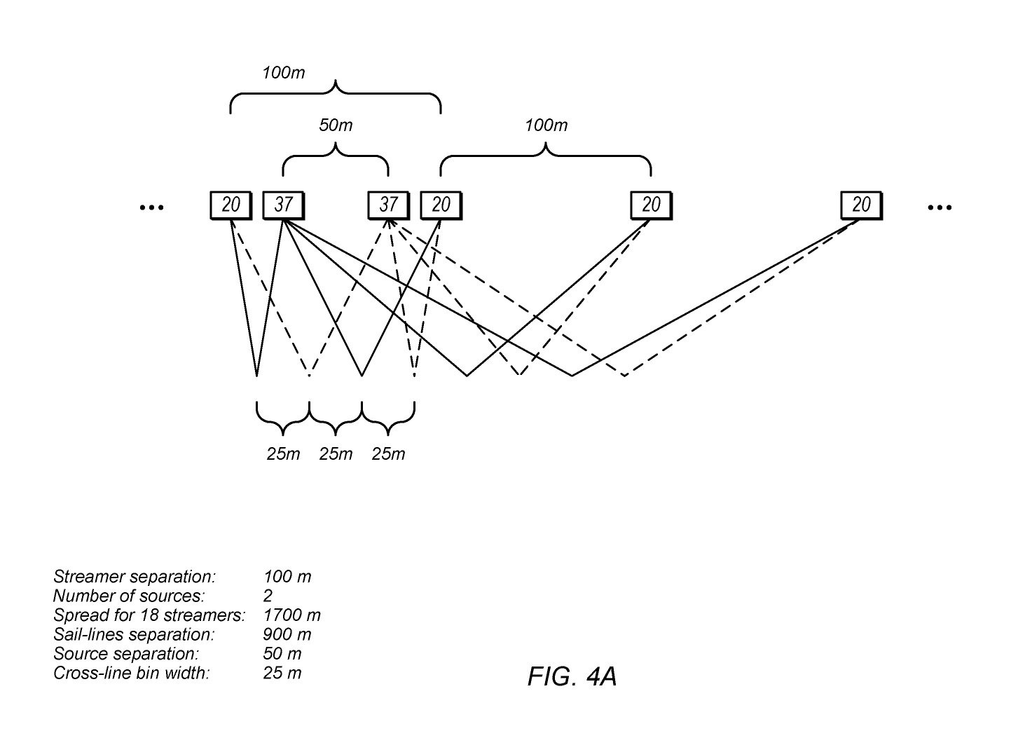

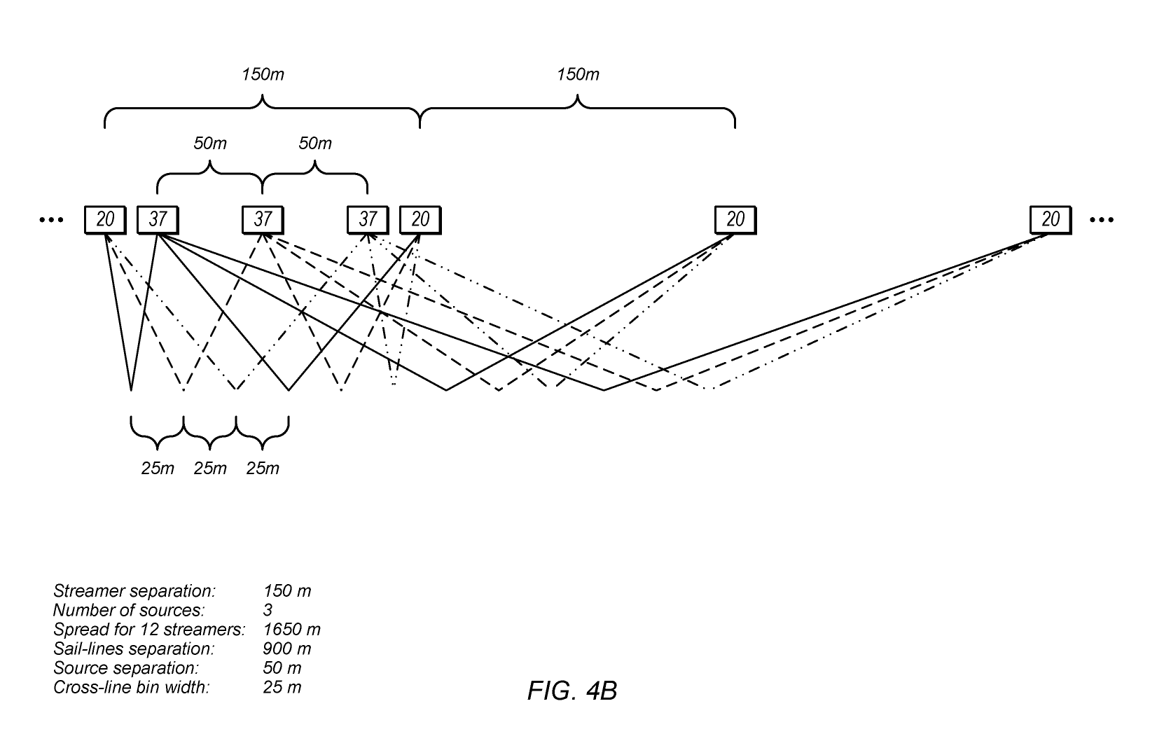

Typically, in seismic surveys, data is binned using grid of cells (e.g., by grouping data into common-cell gathers for a particular cell). The cross-line bin size (the distance between cell edges in the cross-line direction) may be determined based on the line spacing in the cross-line direction. Further, the “fold” for a particular bin corresponds to the number of common mid point locations that are gathered for that bin. In some embodiments, using three or more narrow-towed vibratory sources 37 simultaneously may allow increased separation of streamers 20 without increasing cross-line bin size or reducing fold (which may reduce the number of streamers 20 needed to achieve a particular bin coverage and/or reduce survey time) and/or may reduce the size of cross-line bins, relative to traditional survey techniques. Note that reducing the cross-line bin size may increase resolution of image data in the cross-line direction. FIGS. 4A and 4B, discussed in further detail below, show specific non-limiting examples of relationships between streamer separation, source separation, bin size, and the number of sources. Speaking generally, in disclosed embodiments, a relatively large number of sources operate simultaneously in a relatively narrow cross-line region.

Survey vessel 10 may be configured to move along the surface of body of water 11 such as a lake or the ocean. In the illustrated embodiment, survey vessel 10 tows streamers 20, signal sources 37, and paravanes 14. In other embodiments, at least a portion of streamers 20 may be towed by a second survey vessel (not shown), in place of or in addition to survey vessel 10. Similarly, in some embodiments, at least a portion of signal sources 37 may be towed by one or more additional survey vessels in place of or in addition to survey vessel 10. In these embodiments, the signal sources 37 may be towed within various cross-line positions discussed herein relative to certain ones or groups of the streamers, even when towed by another vessel.

Survey vessel 10 may include equipment, shown generally at 12 and for convenience collectively referred to as “survey equipment.” Survey equipment 12 may include devices such as a data recording unit (not shown separately) for making a record of signals generated by various geophysical sensors in the system 100. Survey equipment 12 may also include navigation equipment (not shown separately), which may be configured to control, determine, and record, at selected times, the geodetic positions of: survey vessel 10, each of a plurality of geophysical sensors 22 disposed at spaced-apart locations on streamers 20, and/or signal sources 37. Geodetic position may be determined using various devices, including global navigation satellite systems such as the global positioning system (GPS), for example. In the illustrated embodiment, survey vessel 10 includes geodetic positioning device 12A. Additional positioning devices may be placed at various locations on streamers 20 in some embodiments. In some embodiments, survey equipment 12 is configured to control sources 37, e.g., to indicate when they should activate, where they should be positioned, what codes they should use, etc.

In the geophysical survey system 100 shown in FIG. 1, survey vessel 10 tows three signal sources 37. In various embodiments, survey vessel 10 may tow any appropriate number of signal sources, including as few as none (e.g., when sources are towed by another vessel) or as many as six or more. In various embodiments, narrow towing of two or more sources may produce various survey advantages, discussed in further detail below. The location of the signal sources may be centered behind survey vessel 10 or displaced from the center line, and may be at various distances relative to survey vessel 10, including attached to the hull. In some embodiments, signal sources 37 are vibratory signal sources. Each signal source 37 may include an array (e.g., a string) of multiple signal sources. Signal sources in the same string or array may be driven using the same code or different codes. Using multiple vibratory sources driven by the same code may increase the amplitude of the source signals, for example. Signals received by sensors 22 may be separated based on the originating vibratory source using cross-correlation, for example. This separation may be performed by survey equipment 12 or may be performed on-shore, for example. The term “vibratory source” may refer to a single vibratory source or to an array of vibratory source elements driven using the same code. In various embodiments, a geophysical survey system may include any appropriate number of towed signal sources 37. In the illustrated embodiment, signal sources 37 are each coupled to survey vessel 10 at one end through a winch 19 or a similar spooling device that enables changing the deployed length of each signal source cable. Survey equipment 12 may include signal source control equipment (not shown separately) for selectively operating and maneuvering signal sources 37.

Geophysical sensors 22 on streamers 20 may be any type of geophysical sensor known in the art. Examples include hydrophones and/or geophones in some embodiments. Non-limiting examples of such geophysical sensors may include particle motion responsive seismic sensors such as geophones and accelerometers, pressure responsive seismic sensors such as hydrophones, pressure-time-gradient responsive seismic sensors, electrodes, magnetometers, temperature sensors or combinations of the foregoing. In various implementations of the disclosure, geophysical sensors 22 may measure, for example, seismic field energy indicative of the response of various structures in the Earth's subsurface formation below the bottom of body of water 11 to energy imparted into the subsurface formation by one or more of signal sources 37. Seismic energy, for example, may originate from signal sources 37 deployed in body of water 11 and towed by survey vessel 10. In some embodiments, streamers 20 include tail buoys 25.

In some embodiments, streamers 20 may include steering devices such as birds 29 configured to maintain streamers 20 in a desired position (e.g., at a specified depth and/or cross-line displacement). Similarly, steering devices may be used to facilitate positioning of sources 37. In some embodiments, survey equipment 12 may be configured to tow streamers 20 using various geometries such as different feather angles, depth profiles etc. In some embodiments, streamers 20 may include multiple geodetic positioning devices (not shown).

In the geophysical survey system 100 shown in FIG. 1, survey vessel 10 tows four streamers 20. In various embodiments, survey vessel 10 may tow any appropriate number of streamers, including as few as none (e.g., when streamers are towed by another vessel) or as many as 26 or more. In various embodiments, streamers 20 may include any of various appropriate modules in addition to geophysical sensors 22. In geophysical survey systems such as shown in FIG. 1 that include a plurality of laterally spaced-apart streamers, streamers 20 are typically coupled to towing equipment that secures the forward end of each of streamers 20 at a selected cross-line position with respect to adjacent streamers and with respect to survey vessel 10. For example, as shown in FIG. 1, the towing equipment may include two paravanes 14 coupled to survey vessel 10 via paravane tow ropes 8. In the illustrated embodiment, paravanes 14 are the outermost components in the streamer spread and may be used to provide cross-line streamer separation. In some embodiments, survey vessel 10 may be configured to tow different streamers 20 at different depths and/or different cross-line displacements from a centerline of survey vessel 10.

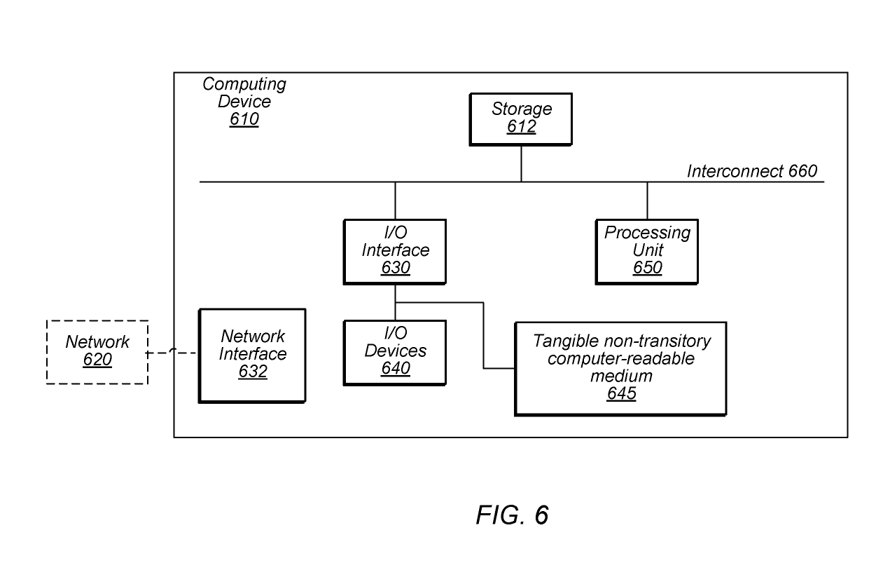

Survey equipment 12, in one embodiment, includes a computing system (an exemplary embodiment of which is discussed below with reference to FIG. 6) configured to, inter alia, process signals from geophysical sensors 22. In other embodiments, a computing system at another location may process signals gathered by geophysical survey system 100 (e.g., on land after a survey has been conducted). A computing system may include or be configured to access a non-transitory storage medium having instructions stored thereon that are executable to perform various operations described herein in order to conduct a survey or to generate one or more images using data acquired during a survey. A computing system may include one or more processors configured to execute the program instructions to cause a system to perform various functionality described herein.

Exemplary Embodiments with Towed Strings of Vibratory Sources

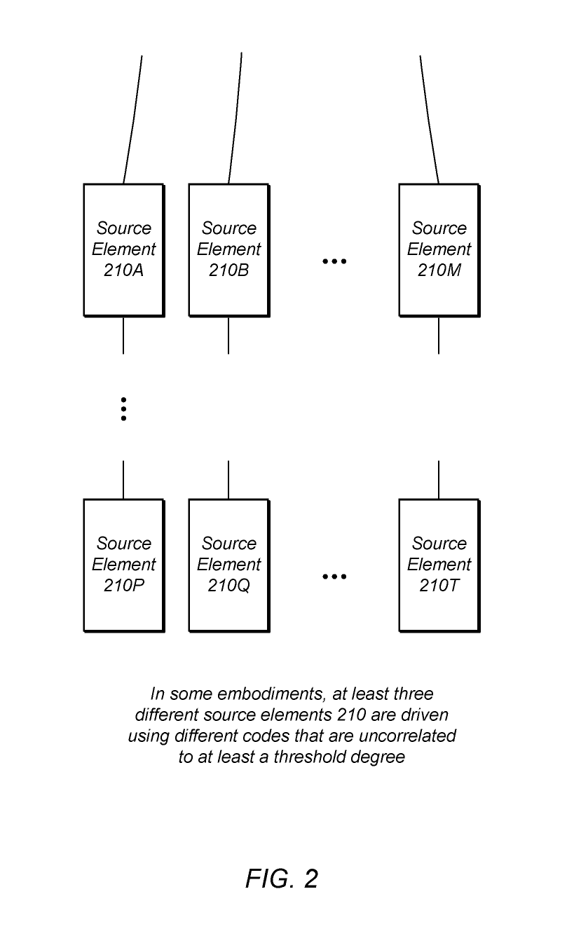

FIG. 2 is a block diagram illustrating multiple strings of source elements 210A-210T. In some embodiments, each source element 210 includes a vibratory element configured to generate seismic energy. In some embodiments, each source 37 in FIG. 1 includes one or more source elements 210. In some embodiments, survey equipment 12 is configured to control source elements 210 to generate vibrations based on codes that are differentiable using cross-correlation. In some embodiments, the source elements 210 in a given string are driven using the same code in one or more survey modes. For example, source elements 210A and 210P may be driven using the same code. In some embodiments, two source elements 210 in a given string are driven using different codes in one or more survey modes. In various embodiments, any appropriate number of strings of source elements 210 may be towed and any appropriate number of source elements 210 per string may be included (including a single source element per string).

Each string may be buoyed using one or more floats. In some embodiments, a single float is used to buoy multiple source elements 210 in a string. For example, a float may be oblong and multiple source elements 210 may be suspended from the float.

As shown in FIG. 2, in some embodiments at least three different source elements 210 are driven using different codes that are uncorrelated to at least a threshold degree, which may allow separation of detected signals during signal processing.

### Exemplary Narrow-Tow Areas

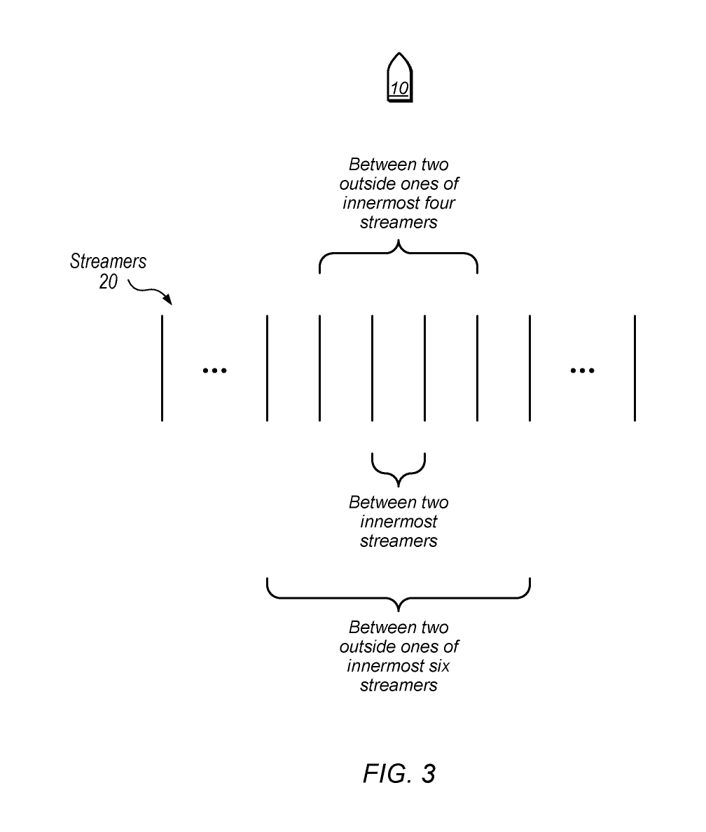

FIG. 3 is a diagram illustrating exemplary regions of “narrow” towing for vibratory sources, according to some embodiments. As discussed in further detail below, the term “narrow” may refer to various cross-line regions, in various embodiments, and these regions may be defined using explicitly distances (e.g., from the centerline) or in relation to other survey elements (e.g., between certain sets of streamers, within a certain percentage of the overall streamer spread, etc.). In FIG. 3, the survey vessel 10 tows a number of streamers 20. In some embodiments, vessel 10 tows two or more vibratory sources between two innermost streamers in a cross-line direction. In this configuration, the cross-line separation between the outermost sources may be less than the cross-line separation between the two innermost streamers.

Note that the narrow towing of sources may be performed by survey vessel 10 or by another vessel. In various embodiments, all or a portion of vibratory sources used simultaneously may be towed by a different vessel than a vessel towing sensor streamers. In some embodiments, vessel 10 is configured to tow a first set of vibratory sources and another vessel is configured to tow a second set of vibratory sources and the first and second sets may sweep simultaneously. In order to perform these simultaneous sweeps, different vessels may communicate to perform time synchronization or may determine timing without direct communications, e.g., using another system such as a global satellite navigation system. In some embodiments, source activation points and recording vessel locations are determine before the start of the survey such that, when the recording vessel is in a pre-determined position, the source vessel activates the source in a pre-determined location.

In some embodiments, vessel 10 tows two or more vibratory sources between outer ones of a group of four innermost streamers in a cross-line direction, as shown. In these embodiments, the cross-line separation between the outermost sources may be less than the cross-line separation between the two outer streamers in the group of four streamers.

In some embodiments, vessel 10 tows two or more vibratory sources between outer ones of a group of six innermost streamers in a cross-line direction, as shown. In these embodiments, the cross-line separation between the outermost sources may be less than the cross-line separation between the two outer streamers in the group of six streamers.

In some embodiments, all the sources used in a survey are towed between the two innermost streamers of the streamer array, relative to the centerline of tow.

In some embodiments, three or more sources may be towed with a cross-line distance of 150 meters or less between the outermost sources. In other embodiments or other survey modes, other maximum cross-line separations between outermost sources may be implemented, including 80 meters or less, 100 meters or less, 120 meters or less, 150 meters or less, 180 meters or less, 200 meters or less, etc. In some embodiments, the cross-line distance between the outermost sources may be a function of the number of strings of sources towed. For example, N strings of sources may be towed with a cross-line distance of 50N meters or less between the outermost sources. In some embodiments, a number of orthogonal codes M are used to drive sources elements of the strings, where M is greater than or equal to N.

In various embodiments, multiple sources may be narrowly towed. The above discussion provides objective examples of narrow towing regions but is not intended to limit the scope of the present disclosure. In various embodiments, various other parameters may be used to define the narrowness of towing

Coverage Examples with Narrow-Towed Sources

FIGS. 4A and 4B illustrate exemplary coverage details for different numbers of narrow-towed sources. FIGS. 4A and 4B represent a view from behind a system of sources 37 and streamers 20, looking parallel to the direction of travel of the towing vessel. As shown, FIG. 4B includes a greater number of sources 37 than FIG. 4A and there is a wider cross-line spacing of streamers in FIG. 4B relative to FIG. 4A.

In particular, FIG. 4A uses two distinguishable sources 37 and FIG. 4B uses three distinguishable sources 37. As greater numbers of narrow-towed distinguishable sources are used, cross-line bin size may be maintained with larger separation between streamers 20 or cross-line bin size may be reduced using a given separation between streamers 20 (e.g., when the mid-points between different source/receiver pairs are closer together). FIGS. 4A and 4B represent the former situation where a greater separation is used in FIG. 4B relative to FIG. 4A, using a larger number of distinguishable vibratory sources 37.

In the example of FIG. 4A, two sources 37 are separated by 50 meters in the cross-line direction. In the illustrated example, streamers 20 are separated by 100 meters in the cross-line direction. In the illustrated example, the cross-line spread for all of the streamers is 1700 meters and a sail line separation (between survey passes) of 900 meters is implemented. As shown, the exemplary configuration of FIG. 4A results in a 25 meter cross-line bin width. Note that only a portion of the eighteen streamers of the example of FIG. 4A are explicitly shown.

In the example of FIG. 4B, a separation of 50 meters in the cross-line direction is maintained between ones of three sources 37. In this example, the nominal cross-line distance between the outermost sources 37 is 100 meters. Note that various distances discussed herein are nominal distances, but may change slightly during a survey—within acceptable bounds—as is well understood by those skilled in the art. In the illustrated example, if twelve streamers are used at a separation of 150 m, the cross-line spread for all of the streamers is 1650 meters and a sail line separation of 900 meters may be implemented.

As shown, the exemplary configuration of FIG. 4B also results in a 25 meter cross-line bin width. Thus, adding another source 37 allows greater separation between streamers 20, relative to the example of FIG. 4A, without increasing cross-line bin size. Similarly, cross-line bin size may be reduced by adding additional separable sources, if the cross-line distance between streamers is maintained. In various embodiments, this may reduce the cost of the survey system, e.g., by requiring a smaller number of streamers to obtain the same coverage. In various embodiments, this may improve survey performance, e.g., by increasing resolution. In various embodiments, this may also reduce the complexity of the survey system and may reduce entanglement of streamers 20.

In various embodiments, using more than three separable sources may further reduce cross-line bin size and/or allow increased streamer separation. These advantages may be difficult or impossible to obtain using traditional sources such as air guns or traditional configurations such as wide tow of survey sources. Using air guns, for example, may require delays between firing from different sources in order to distinguish among them, which may reduce fold and/or increase bin size because of vessel movement during the delays.

Consider, for example, an exemplary configuration with six vibratory sources and a streamer separation of 200 meters. In this example, the size of cross-line bins may be approximately 16.6 meters. As another example, with a streamer separation of 50 meters and six sources, the size of cross-line bins may be approximately 6.25 meters. Thus, survey efficiency and/or data quality may be increased without reducing fold in cross-line bins.

### Survey Method Based on Coverage Parameters

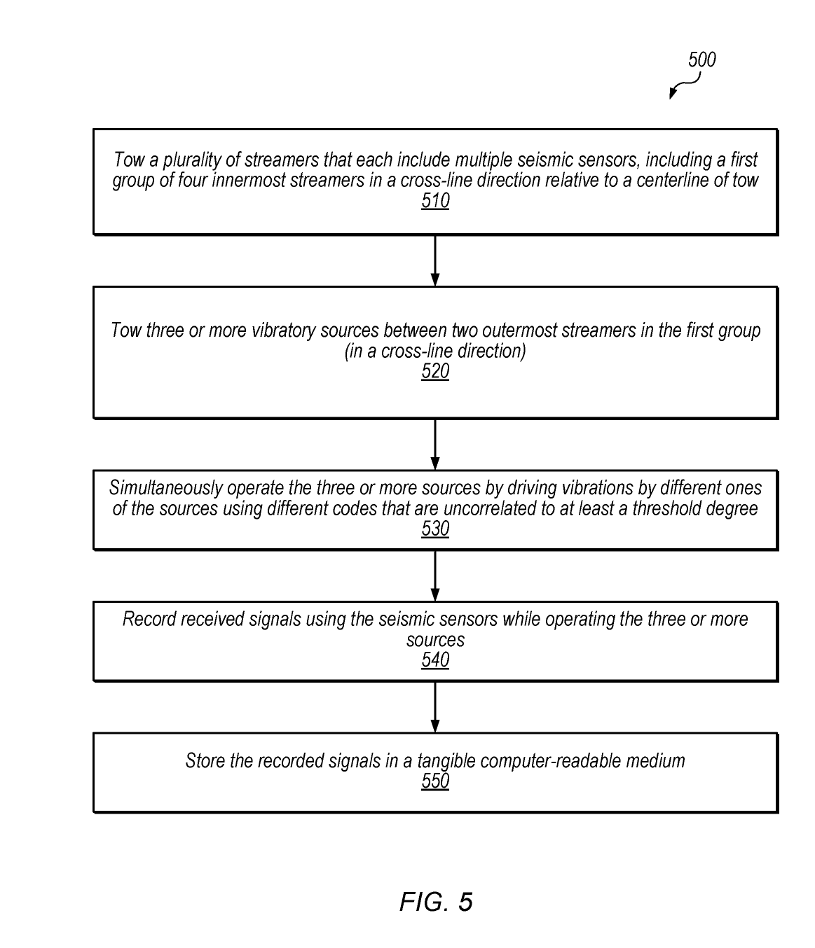

Referring now to FIG. 5, an exemplary method 500 for simultaneously operating narrow-towed sources is shown, according to some embodiments. The method shown in FIG. 5 may be used in conjunction with any of the computing systems, devices, elements, or components disclosed herein, among other devices. In various embodiments, some of the method elements shown may be performed concurrently, in a different order than shown, or may be omitted. Additional method elements may also be performed as desired. Flow begins at block 510.

At 510, in the illustrated embodiment, one or more vessels tow a plurality of streamers that each include multiple seismic sensors, including a first group of four innermost streamers in a cross-line direction relative to a centerline of tow. Seismic sensors “included” on a streamer may be physically incorporated into the streamer or may be otherwise attached to the streamer (e.g., such that they can be detached when not in use).

At 520, in the illustrated embodiment, one or more vessels tow two or more vibratory sources between two outermost streamers in the first group in a cross-line direction. Said another way, the vibratory sources do not extend past either of these outermost streamers in the cross-line direction. Also, in this situation, a cross-line distance between the two outermost ones of the sources is smaller than a cross-line distance between the two outermost streamers in the first group. In some embodiments, the two or more sources include three, five, seven, or nine vibratory sources, or any other appropriate number, and are towed between the two outermost streamers. Each source may include a single vibratory element or multiple vibratory elements that are driven using the same code.

In some embodiments, a set of vibratory sources is towed between a second group of two innermost streamers in the cross-line direction (e.g., which may be narrower than between the two outermost streamers in the first group). In some embodiments, for a survey or survey pass, only the two or more vibratory sources that are narrow towed are used to emit energy (such that other seismic sources are not used for the survey or survey pass). In other embodiments, additional vibratory or non-vibratory sources that are not narrowly towed may be used during a given survey pass, e.g., using wide tow or tow by another vessel, in addition to the narrow-towed sources. In some embodiments, all or a portion of the streamers and/or all or a portion of the sources may be towed by different vessels. For example, a first vessel may tow all or a portion of the sources and a second vessel may tow all or a portion of the streamers.

At 530, in the illustrated embodiment, control equipment simultaneously operates the two or more sources by driving different vibrations of the sources using different codes that are uncorrelated to at least a threshold degree. This may involve actually transmitting the different codes to the sources or sending control information that specifies different pre-programmed codes for the sources to use, for example.

At 540, in the illustrated embodiment, survey equipment records received signals using the seismic sensors while operating the two or more sources. In various embodiments, the seismic sensors receive signals reflected from one or more subsea formations based on energy emitted by ones of the two or more sources. As discussed above, because of orthogonality among the codes, signals received based on energy emitted from different sources may be separated in the recorded data, e.g., using cross-correlation. This processing may be performed on vessel 10 or after survey data is transferred onshore, for example.

At 550, the recorded signals are stored in a tangible, computer-readable medium. The recorded signals (and/or results of processing the recorded signals) may be referred to as a geophysical data product. In various embodiments, the disclosed techniques may simplify equipment used for towing sources (e.g., relative to wide-tow implementations), reduce survey complexity without reducing resolution, and/or increase resolution without increasing survey complexity, for example.

In some embodiments, vibratory source elements may be towed in strings, or one of various different type of connected arrays that include multiple source elements. In some embodiments, two or more (or all of) the sources that are in the same string of sources are driven using the same code. This may increase the amplitude of energy emitted using that code, for example. In other embodiments, two different sources in the same string of sources may be driven using different codes.

### Exemplary Computing Device

Turning now to FIG. 6, a block diagram of one embodiment of computing device (which may also be referred to as a computing system) 610 is depicted. Computing device 610 may be used to implement various portions of this disclosure. Computing device 610 may be any suitable type of device, including, but not limited to, a personal computer system, desktop computer, laptop or notebook computer, mainframe computer system, web server, workstation, or network computer. As shown, computing device 610 includes processing unit 650, storage 612, input/output (I/O) interface 630 coupled via an interconnect 660 (e.g., a system bus). I/O interface 630 may be coupled to one or more I/O devices 640. Computing device 610 further includes network interface 632, which may be coupled to network 620 for communications with, for example, other computing devices.

As described above, processing unit 650 includes one or more processors. In some embodiments, processing unit 650 includes one or more coprocessor units. In some embodiments, multiple instances of processing unit 650 may be coupled to interconnect 660. Processing unit 650 (or each processor within 650) may contain a cache or other form of on-board memory. In some embodiments, processing unit 650 may be implemented as a general-purpose processing unit, and in other embodiments it may be implemented as a special purpose processing unit (e.g., an ASIC). In general, computing system 610 is not limited to any particular type of processing unit or processor subsystem.

As used herein, the terms “processing unit” or “processing element” refer to circuitry configured to perform operations or to a memory having program instructions stored therein that are executable by one or more processors to perform operations. Accordingly, a processing unit may be implemented as a hardware circuit implemented in a variety of ways. The hardware circuit may include, for example, custom very-large-scale integration (VLSI) circuits or gate arrays, off-the-shelf semiconductors such as logic chips, transistors, or other discrete components. A processing unit may also be implemented in programmable hardware devices such as field programmable gate arrays, programmable array logic, programmable logic devices, or the like. A processing unit may also be configured to execute program instructions from any suitable form of non-transitory computer-readable media to perform specified operations.

Storage subsystem 612 is usable by processing unit 650 (e.g., to store instructions executable by and data used by processing unit 650). Storage subsystem 612 may be implemented by any suitable type of physical memory media, including hard disk storage, floppy disk storage, removable disk storage, flash memory, random access memory (RAM-SRAM, EDO RAM, SDRAM, DDR SDRAM, RDRAM, etc.), ROM (PROM, EEPROM, etc.), and so on. Storage subsystem 612 may consist solely of volatile memory in one embodiment. Storage subsystem 612 may store program instructions executable by computing device 610 using processing unit 650, including program instructions executable to cause computing device 610 to implement the various techniques disclosed herein.

I/O interface 630 may represent one or more interfaces and may be any of various types of interfaces configured to couple to and communicate with other devices, according to various embodiments. In one embodiment, I/O interface 630 is a bridge chip from a front-side to one or more back-side buses. I/O interface 630 may be coupled to one or more I/O devices 640 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

Various articles of manufacture that store instructions (and, optionally, data) executable by a computing system to implement techniques disclosed herein are also contemplated. These articles of manufacture include non-transitory computer-readable memory media. The contemplated non-transitory computer-readable memory media include portions of a memory subsystem of a computing device as well as storage media or memory media such as magnetic media (e.g., disk) or optical media (e.g., CD, DVD, and related technologies, etc.). The non-transitory computer-readable media may be either volatile or nonvolatile memory.

In some embodiments, a geophysical data product may be produced. The geophysical data product may include processed geophysical data and may be stored on a non-transitory, tangible computer-readable medium. The geophysical data product may be processed offshore (i.e. by equipment on a survey vessel) or onshore (i.e. at a facility on land). Geophysical analysis may be performed on the data product either offshore or onshore. The geophysical analysis may determine various characteristics of the geophysical formation which may be useful for location and/or extraction of mineral deposits. In some embodiments, the geophysical data product may be stored using tangible, non-transitory computer-readable storage medium 645. This medium may or may not be included in device 610 and may store processed and/or unprocessed geophysical data from device 610.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method of manufacturing a geophysical data product, comprising:
towing a plurality of streamers that each include multiple seismic sensors, wherein the plurality of streamers includes a first group of four innermost streamers in a cross-line direction relative to a centerline of tow;
towing two or more vibratory sources between, in the cross-line direction, two outermost streamers in the first group;
simultaneously operating the two or more sources, while towing, by driving vibrations by different ones of the sources using different codes that are uncorrelated to at least a threshold degree;
recording received signals using the seismic sensors while operating the two or more sources; and
storing the recorded signals in a tangible computer-readable medium.

2. The method of claim 1, wherein two or more of the sources are included in a towed string of seismic sources.

3. The method of claim 2, wherein two different sources in a same string of sources are driven using a same code.

4. The method of claim 2, wherein two different sources in a same string of sources are driven using different codes.

5. The method of claim 1, wherein the two outermost sources are towed within 150 meters of each other in the cross-line direction.

6. The method of claim 1, further comprising separating signals detected by the plurality of streamers, based on which of the sources generated the signals, using cross-correlation.

7. The method of claim 1, wherein the plurality of streamers includes a second group of two innermost streamers and wherein the towing includes towing the two or more vibratory sources between the two innermost streamers in the cross-line direction.

8. The method of claim 1, wherein one or more of the sources include multiple vibratory source elements.

9. The method of claim 1, wherein at least a portion of the plurality of streamers and the two or more vibratory sources are towed by different vessels.

10. The method of claim 1, wherein the sources are towed with a first nominal separation distance in the cross-line direction and wherein each of the plurality of streamers is separated, in the cross-line direction, by more than double the first nominal separation distance.

11. The method of claim 1, further comprising:
importing the tangible computer-readable medium onshore; and
performing geophysical analysis on the data product onshore.

12. A system, comprising:
a plurality of streamers that each include multiple seismic sensors;
two or more vibratory sources; and
tow equipment configured to:
tow the plurality of streamers behind a survey vessel such that the plurality of streamers includes a first group of four innermost streamers in a cross-line direction relative to a centerline of tow; and
tow the two or more vibratory sources between, in the cross-line direction, two outermost streamers in the first group;
control equipment configured to:
simultaneously operate the two or more sources, while towed, by driving vibrations by different ones of the sources using different codes that are uncorrelated to at least a threshold degree;
record received signals using the seismic sensors while operating the two or more sources; and
store the recorded signals in a tangible computer-readable medium.

13. The system of claim 12, wherein two or more of the sources are included in a string of seismic sources.

14. The system of claim 13, wherein the control equipment is configured to drive all sources in a same string of sources using the same code.

15. The system of claim 13, wherein the control equipment is configured to drive two different sources in a same string of sources using different codes.

16. The system of claim 12, wherein the two or more sources include at least three sources and wherein the tow equipment is configured to tow two outermost sources of the at least three sources within 200 meters of each other in the cross-line direction.

17. The system of claim 12, wherein one or more of the sources include multiple vibratory source elements.

18. The system of claim 12, wherein the two or more sources include at least five sources and the different codes include at least five different codes that are uncorrelated to the threshold degree.

19. The system of claim 12 wherein different portions of the tow equipment are configured to be towed behind different survey vessels.

20. One or more non-transitory computer-readable media having instructions stored thereon that are executable by a computing device to perform operations comprising:
steering ones of a plurality of towed streamers that each include multiple seismic sensors, wherein the plurality of streamers includes a first group of four innermost streamers in a cross-line direction relative to a centerline of tow;
steering ones of two or more vibratory sources that are towed between, in the cross-line direction, two outermost streamers in the first group;
controlling the two or more sources to simultaneously operate the two or more sources, while towing, by driving vibrations by different ones of the sources using different codes that are uncorrelated to at least a threshold degree;
recording received signals using the seismic sensors while operating the two or more sources; and
storing the recorded signals in a tangible computer-readable medium.
